(19) United States
(12) Patent Application Publication
(10) Pub. No.: US 2008/0055516 A1
(43) Pub. Date: Mar. 6, 2008

(54) Display Device Having Heat Pipe

(76) Inventors: Dong-Jin Seo, Cheonan-si (KR); Yong-woo Lee, Suwon-si (KR)

Correspondence Address: Frank Chau, Esq.;F. CHAU & ASSOCIATES, LLC, 130 Woodbury Road, Woodbury, NY, 11797, US

(21) Appl. No.: 11/849,895

(22) Filed: Sep. 4, 2007

(30) Foreign Application Priority Data
Sep. 1, 2006 (KR) 10-2006-0084341

(51) Int. Cl. G02F 1/13357

(52) U.S. Cl. 349/65

(57) ABSTRACT

A display device includes a liquid crystal display panel, a light guiding plate disposed behind the liquid crystal display panel, a light source unit disposed at a side of the light guiding plate, and a light source cover encompassing the light source unit for reflecting light from the light source unit to the light guiding plate, and including a plate in which a plurality of heat pipe are formed.

### CROSS-REFERENCE TO RELATED APPLICATION

This application claims priority from Korean Patent Application No. 2006-0084341, filed on Sep. 1, 2006 in the Korean Intellectual Property Office, the disclosure of which is incorporated herein by reference in its entirety.

### BACKGROUND OF INVENTION

1. Field of Invention

Apparatuses and methods consistent with embodiments of the present invention relate to a display device, and more particularly, to a display device which employs a heat pipe to alleviate heat generated in a light source.

2. Description of Related Art

Flat panel display devices, such as a liquid crystal display (LCD), a plasma display panel (PDP), an organic light emitting diode (OLED), etc., are widely used in place of cathode ray tubes (CRTs).

An LCD includes an LCD panel and a backlight unit disposed behind a thin film transistor (TFT) substrate to provide light. Transmittance of the light generated by the backlight unit is adjusted according to an alignment of liquid crystals of the LCD panel.

The backlight unit may be either an edge type backlight unit or a direct type backlight unit according to a position of a light source. In the edge type backlight unit, a light source is installed on a side of a light guiding plate. The edge type backlight unit is typically used with small LCD devices such as a monitor for a laptop computer or a monitor for a desktop computer.

The edge type backlight unit uses a lamp or the like as a light source, and generates more heat than the backlight unit. If the heat is not efficiently radiated, the liquid crystals may change from a liquid crystal phase to a liquid phase. Accordingly, an image may be degraded. Moreover, as a high voltage is applied to the light source for high brightness, a phase change of the liquid crystals becomes even more serious.

### SUMMARY OF THE INVENTION

According to an embodiment of the present invention a display device comprises a liquid crystal display panel; a light guiding plate disposed behind the liquid crystal display panel, a light source unit disposed at a side of the light guiding plate, and a light source cover encompassing the light source unit, for reflecting light from the light source unit to the light guiding plate, and comprising a plate in which a plurality of heat pipe are formed.

According to an embodiment of the invention, the heat pipes extend substantially parallel with each other.

According to an embodiment of the invention, the light source unit extends in a lengthwise direction, and the heat pipes extend in the lengthwise direction of the light source unit.

According to an aspect of the invention, the light source unit comprises a body and electrode parts, the electrode parts disposed at opposite end parts of the body.

According to an embodiment of the invention, the plate comprises a first part corresponding to the electrode parts and a second part corresponding to at least a portion of the body.

According to an embodiment of the invention, the display device further comprises a radiation member of which at least a portion is in contact with the second part.

According to an embodiment of the invention, the radiation member comprises a heat sink.

According to an embodiment of the invention, the plate encompasses the light source unit and is formed in a single body.

According to an embodiment of the invention, the light source cover further comprises a light source reflecting plate disposed between the plate and the light source unit, and light from the light source unit is reflected by the light source reflecting plate.

According to an embodiment of the invention, the light source reflecting plate comprises polyethylene terephthalate (PET).

According to an embodiment of the invention, the light source cover further comprises a reflective layer which is coated on an inner surface of the plate, and light from the light source unit is reflected by the reflective layer.

According to an embodiment of the invention, the reflective layer comprises polyethylene terephthalate (PET).

According to an embodiment of the invention, the inner surface of the plate which faces the light source unit is a mirror surface, and light source from the light source unit is reflected by the inner surface of the plate.

According to an embodiment of the invention, a thermal conductivity of the plate in a lengthwise direction of the light source cover is greater than a thermal conductivity thereof in a vertical direction of a surface of the plate.

According to an embodiment of the invention, the display device further comprises a cover which comprises a lower surface substantially parallel with the light guiding plate and a lateral surface bent from the lower surface forming an accommodating space where the light guiding plate and the light source cover are accommodated, wherein the plate is disposed to face the lower surface.

According to an embodiment of the invention, the display device further comprises a gap pad disposed between the plate and the lower surface of the cover, wherein the plate, the gap pad and the lower surface of the cover are adhered in a sequentially stack.

According to an embodiment of the invention, the plate further comprises a plate body encompassing the heat pipes and is formed of a plate shape.

According to an embodiment of the invention, the plate body comprises aluminum.

According to an embodiment of the invention, the light source unit comprises a light emitting diode.

According to an embodiment of the present invention, a display device comprises a liquid crystal display panel, a light guiding plate disposed behind the liquid crystal display panel, a lamp disposed at a side of the light guiding plate, and a lamp cover encompassing the lamp for reflecting light from the lamp to the light guiding plate, wherein a plurality of heat pipes are formed in the lamp cover.

According to an embodiment of the invention, the heat pipes extend substantially parallel with each other.

According to an embodiment of the invention, the lamp extends in a lengthwise direction, and the heat pipes extend in the lengthwise direction of the lamp.

According to an embodiment of the invention, the lamp comprises a body and electrode parts, the electrode parts disposed at opposite end parts of the body.

According to an aspect of the invention, the heat pipes extend to correspond to at least one of the electrode parts and at least a portion of the body.

### BRIEF DESCRIPTION OF THE DRAWINGS

The present invention will become apparent and more readily appreciated from the following description of exemplary embodiments, taken in conjunction with the accompanying drawings, in which:

FIG. 1 is an exploded perspective view of an LCD according to an exemplary embodiment of the present invention.

FIG. 2 is a sectional view of the LCD of FIG. 1.

FIG. 3 is an exploded perspective view of a light source cover in the LCD of FIG. 1.

FIG. 4 is a sectional view taken along IV-IV in FIG. 3.

FIG. 5 is a sectional view take along V-V in FIG. 3.

FIGS. 6A to 6B illustrate heat distribution in the LCD of FIG. 1.

FIG. 7 is a perspective view of a main part of an LCD according to an exemplary embodiment of the present invention.

FIG. 8 is a perspective view of a main part of an LCD according to an exemplary embodiment of the present invention.

FIG. 9 is a sectional view of a main part of an LCD according to an exemplary embodiment of the present invention.

FIG. 10 is a sectional view of a main part of an LCD according to an exemplary embodiment of the present invention.

FIG. 11 is a perspective view of a light source cover of an LCD according to an exemplary embodiment of the present invention.

FIG. 12 is a perspective view of a light source cover of an LCD according to an exemplary embodiment of the present invention.

FIG. 13 is an exploded perspective view of a light source cover of an LCD according to an exemplary embodiment of the present invention.

FIG. 14 is an exploded perspective view of a main part of an LCD according to an exemplary embodiment of the present invention.

### DETAILED DESCRIPTION OF EXEMPLARY EMBODIMENTS

Reference will now be made in detail to embodiments of the present invention, examples of which are illustrated in the accompanying drawings, wherein like reference numerals refer to like elements throughout. While exemplary embodiments describe a display device as an LCD, the display device is not limited to an LCD. Other display devices with a backlight unit are contemplated.

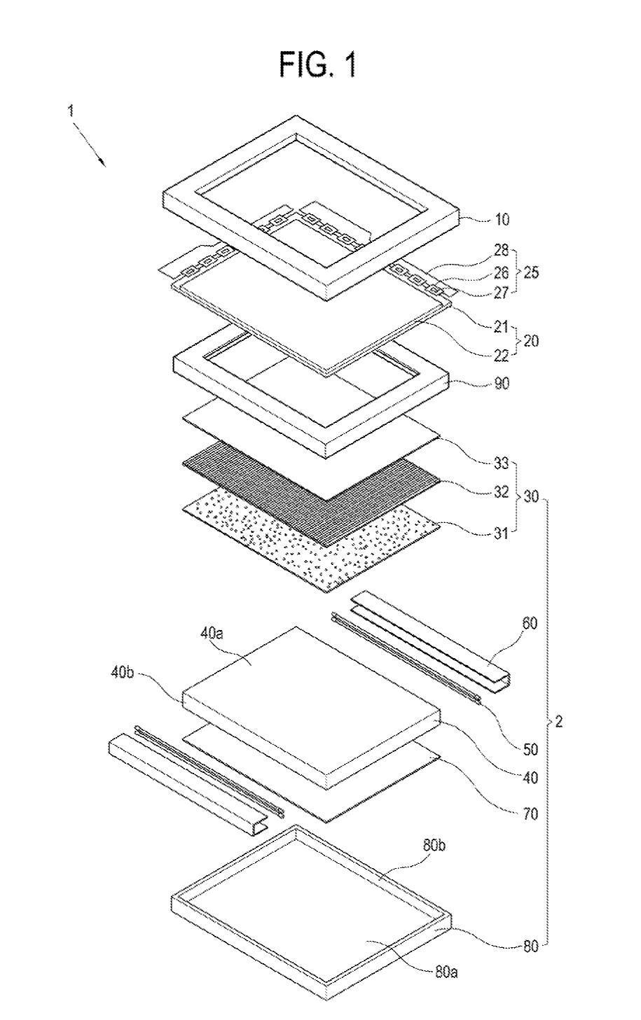

Referring to FIGS. 1 to 5, an LCD according to an exemplary embodiment of the present invention will be described as follows.

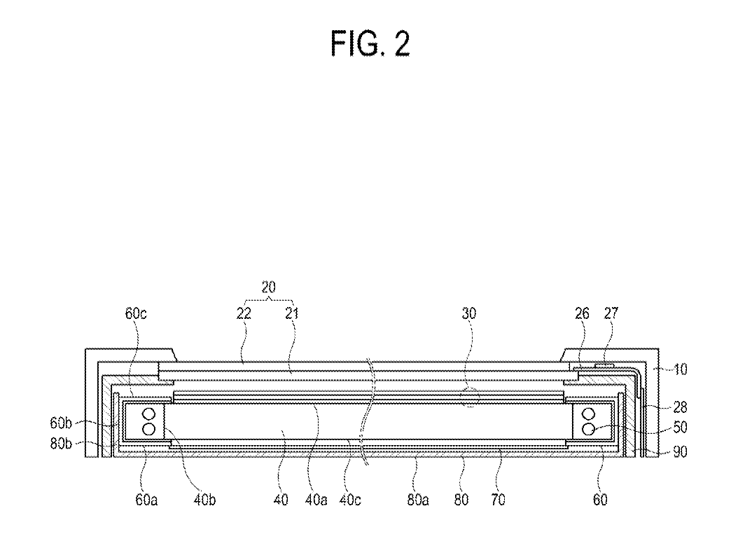

As illustrated in FIGS. 1 and 2, the LCD 1 includes an LCD panel 20 and a backlight unit 2 to provide light to the LCD panel 20. The LCD panel 20 and the backlight unit 2 are accommodated in an upper cover 10 and a lower cover 80. The backlight unit 2 includes an optical member 30, a light guiding plate 40, a light source unit 50, a light source cover 60 and a reflecting plate 70. The LCD panel 20 is seated on a mold 90.

The LCD panel 20 includes a TFT substrate 21 where TFTs are formed and a color filter substrate 22 which faces the TFT substrate 21. A liquid crystal layer (not shown) is disposed between the substrates 21 and 22. The LCD panel 20 adjusts an alignment of liquid crystals in the liquid crystal layer to thereby display images. The light source unit 50 is located behind the LCD panel 20 to provide light to the LCD panel 20. A driving part 25 is provided at one side of the TFT substrate 21 to provide a driving signal. The driving part 25 includes a flexible printed circuit (FPC) 26, a driving chip 27 mounted on the FPC 26 and a printed circuit board (PCB) 28 connected to one side of the FPC 26. The driving part 25 shown in FIG. 1 is formed as a chip on film (COF) type. The driving part 25 may be implemented as a different type, such as tape carrier package (TCP), chip on glass (COG) or the like. Alternatively, the driving part 25 may be formed on the TFT substrate 21 while TFTs are formed.

The optical member 30 disposed behind the LCD panel 20 includes a diffusion film 31, a prism film 32 and a protection film 33.

The diffusion film 31 includes a base plate and a coating layer, such as beads formed on the base plate. The diffusion film 31 diffuses light from the light source unit 50 to provide the light to the LCD panel 20. A plurality of layered diffusion films 31 may be used.

The prism film 32 includes prisms, such as triangular prisms, formed in a predetermined alignment thereon. The prism film 32 collects the light diffused in the diffusion film 31 to be substantially perpendicular to a surface of the LCD panel 20. Two prism films 32 may be used and micro prisms formed on each of the prism films 32 make a predetermined angle with each other. The light passing through the prism film 32 progresses vertically, thereby forming a uniform brightness distribution.

The protection film 33, disposed at the top of the optical member 30, protects the prism film 32, which is vulnerable to scratching.

The light guiding plate 40 disposed below the diffusion plate 31 may be made of acrylic resin and provides the light from the light source unit 50 uniformly to the diffusion film 31. The light guiding plate 40 includes an exiting surface 40a which faces the diffusion film 31, a pair of incident surfaces 40b which faces the light source unit 50 and a reflecting surface 40c which faces the reflecting plate 70.

The light guiding plate 40 is of a rectangular plate, and the light source 50 is provided at each of opposite sides of the light guiding plate 40. In alternative exemplary embodiments, the light guiding plate 40 may be a wedge type, and a light source unit 50 is provided at one side of the light guiding plate 40.

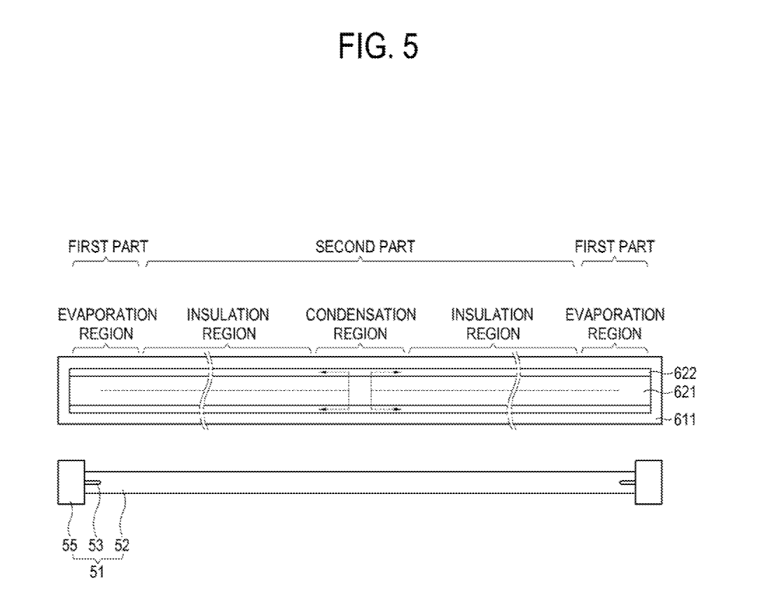

Referring to FIG. 5, the light source unit 50 includes a lamp main body 51 which emits light, lamp holders 55 which each are disposed at opposite end parts of the lamp main body 51. The lamp main body 51 includes a body 52 and electrode parts 53 which are disposed at opposite end parts of the body 52. The light source unit 50 may be provided as a cold cathode fluorescent lamp (CCFL) or an external electrode fluorescent lamp (EEFL).

The light source cover 60 encompasses the light source unit 50 and the incident surfaces 40b of the light guiding plate 40 and reflects the light from the light source unit 50 toward the incident surfaces 40b of the light guiding plate 40.

The light source cover 60 includes a first surface 60a which faces a lower surface 80a of the lower cover 80, a second surface 60b which is bent from the first surface 60a and faces a lateral surface 80b of the lower cover 80, and a third surface 60c which is bent from the second surface 60b toward the light guiding plate 40. The third surface 60c covers a portion of the exiting surface 40a of the light guiding plate 40.

The reflecting plate 70 is disposed below the light guiding plate 40 and reflects incident light toward the light guiding plate 40. The reflecting plate 70 may be formed of polyethylene terephthalate (PET), polycarbonate (PC) or the like.

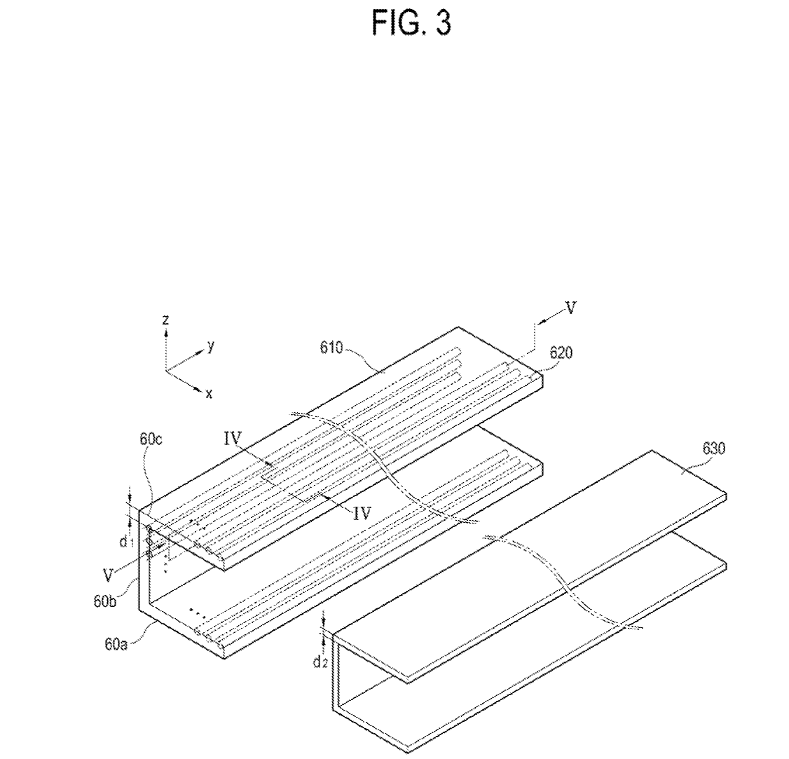

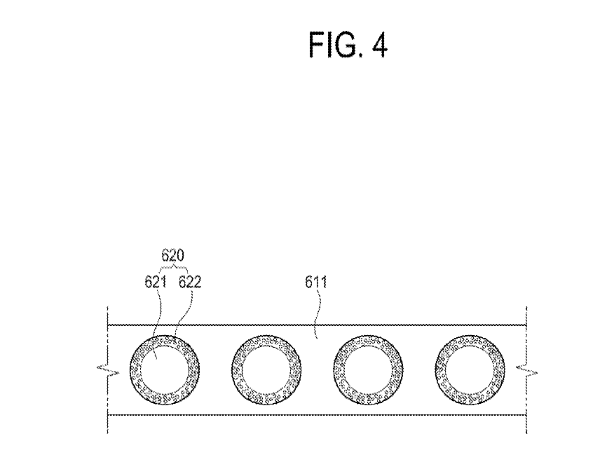

Hereinafter, a configuration of the light source cover 60 will be described with reference to FIGS. 3 and 4.

The light source cover 60 includes a plate 610 and a light source reflecting plate 630. The plate 610 and the light source reflecting plate 630 have a similar shape, and the light source reflecting plate 630 is formed smaller than the plate 610. The light source reflecting plate 630 is disposed inside the plate 610. Here, the light source reflecting plate 630 may be adhered to the plate by an adhesive layer (not shown).

Referring to FIG. 4, a plurality of heat pipes 620 are formed in the plate 610, and a plate body 611 encompasses the heat pipes 620. The plate 610 is bent to encompass the light source unit 50. The plate body 611 may be formed of aluminum, stainless steel or the like.

The heat pipes 620 extend lengthwise and substantially parallel with an extending direction of the light source unit 50 and are formed throughout the plate 610.

The heat pipes 620 have circular cross sections. Alternatively, cross sections of the heat pipes 620 may be oval-shape, polygonal-shape, or the like. The heat pipes 620 include a refrigerant accommodating part 621 and a capillary structure part 622 which encompasses the refrigerant accommodating part 621. The capillary structure part 622 is also referred to as a wick. The refrigerant accommodating part 621 accommodates a refrigerant such as methanol, acetone, water or mercury. The capillary structure part 622 may include porous fiber.

Thermal conductivity of the plate 610 is different depending on directions. The plate 610 has a thermal conductivity of about 10000 W/mK in a direction y, an extending direction of the heat pipes 620, and a thermal conductivity of about 5000 W/mK in other directions, e.g., direction x and direction z.

The thickness d1 of the plate 610 may be about 0.8 mm or less, and is preferably less than 0.6 mm. The thickness d2 of the light source reflecting plate 630 may be about 0.3 mm.

The light source reflecting plate 630 reflects light from the light source unit 50 toward the incident surfaces 40a of the light guiding plate 40 and may include polyethylene terephthalate (PET).

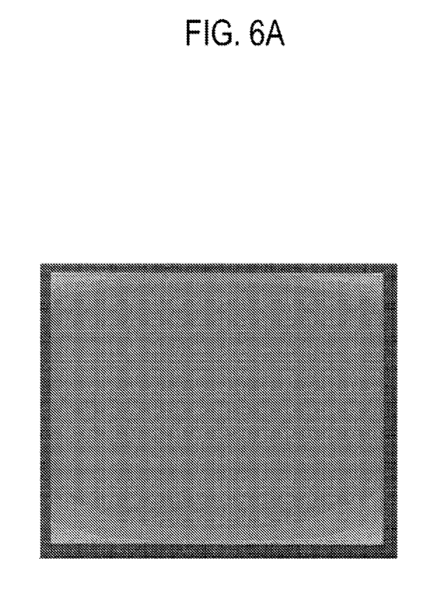

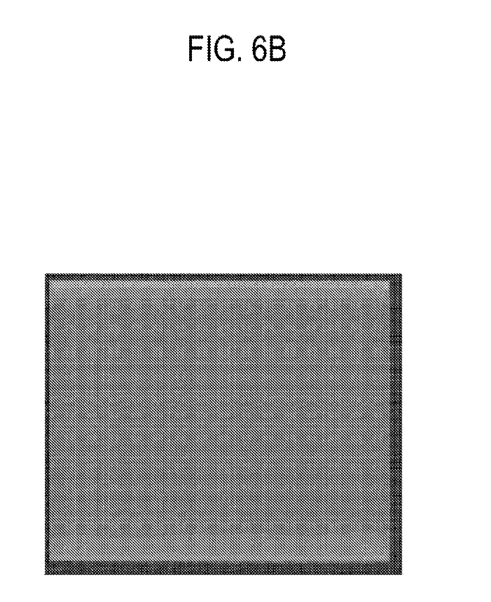

Referring to FIGS. 5, 6A and 6B, a function of the light source cover 60 will be described. FIG. 5 also illustrates the light source unit 50.

The heat pipes 620 are divided into a first part and a second part. The first part is an evaporation region which corresponds to the electrode parts 53 of the light source unit 50, and the second part includes a condensation region which is disposed substantially in a middle of the body 52 of the light source unit 50 and an insulation region between the evaporation region and the condensation region.

Heat generated in the light source unit 50 is transferred to the plate 610 via the light source reflecting plate 630. Since heat is generated in the electrode parts 53 of the light source unit 50, a refrigerant in the evaporation region corresponding to the electrode parts 53 is evaporated. The evaporated refrigerant moves to the condensation region via the insulation region. The refrigerant radiates heat while being condensed in the condensation region. The liquefied refrigerant returns to the evaporation region by capillarity of the capillary structure part 622.

The refrigerant transfers heat while changing its phase between a liquid state and a gaseous state. In alternative exemplary embodiments, a refrigerant may transfer heat without changing its phases, liquid state or gaseous state.

By the foregoing processes, the heat from the electrode parts 53 is transferred to the entire plate 610, thereby substantially preventing a temperature rise in the first part of the light source cover 60. The heat pipes 620 on the plate 610 are formed in a lengthwise direction of the light source unit 50, and thus the heat is even more efficiently transferred.

FIGS. 6A and 6B illustrate temperature distribution of a screen on which the LCD panel displays. The light source units 50 are extended, covering both upper and lower sides of the screen. Dark portions indicate a relatively low temperature, and light portions indicate a relatively high temperature.

FIG. 6A shows temperatures of a screen implemented with an LCD panel without heat pipes, wherein a light source cover includes an aluminum plate. Temperature is high in an upper part and a lower part of the screen and particularly the highest in the corner parts which correspond to the electrode parts of the light source unit. Temperatures at the corners are 43.2° C., 44° C., 44.5° C. and 45.4° C. The liquid crystal layer disposed in the corner of the LCD panel is deteriorated by a high temperature of the electrode parts of the light source unit, thereby degrading a quality of an image being displayed on the screen. Further, the optical member disposed in the corner of the LCD panel may shrink.

According to an exemplary embodiment of the present invention and with reference to FIG. 5B, the light source cover includes heat pipes. Temperature is high in the upper part and the lower part of the screen as compared with a middle part, but decreased substantially as compared with FIG. 6a. That is, the temperatures of corner parts are decreased to a temperature similar to the upper and lower center parts of the screen.

The temperature of the corner parts decreased about 7 to 10 degrees as compared with the those of FIG. 6a. Thus, deterioration of the liquid crystal layer or shrinkage of the optical member decreases.

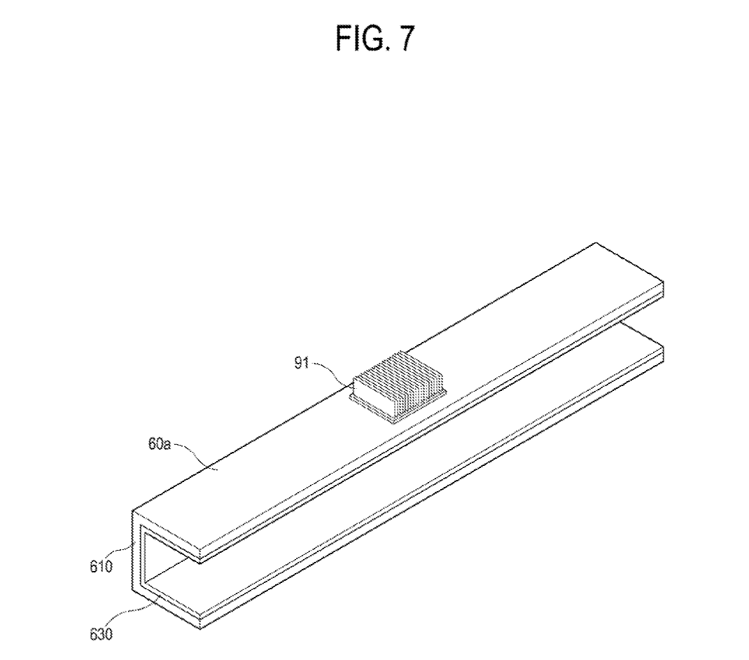

Referring to FIG. 7, an LCD according to an exemplary embodiment of the present invention will be described.

A radiation member 91 is provided on a first surface 60a of a plate 610 which faces a lower surface 80a of a lower cover 80. The radiation member 91 is disposed substantially in the middle of a light source cover 60, within a second part (see FIG. 5).

The radiation member 91 is provided as a heat sink that radiates heat emitted by a refrigerant being condensed through a wide surface, e.g., a plurality of fins, to the outside. Thus, temperature becomes low and uniform throughout the light source cover 60. The radiation member 91 may be modified variously in shape and position.

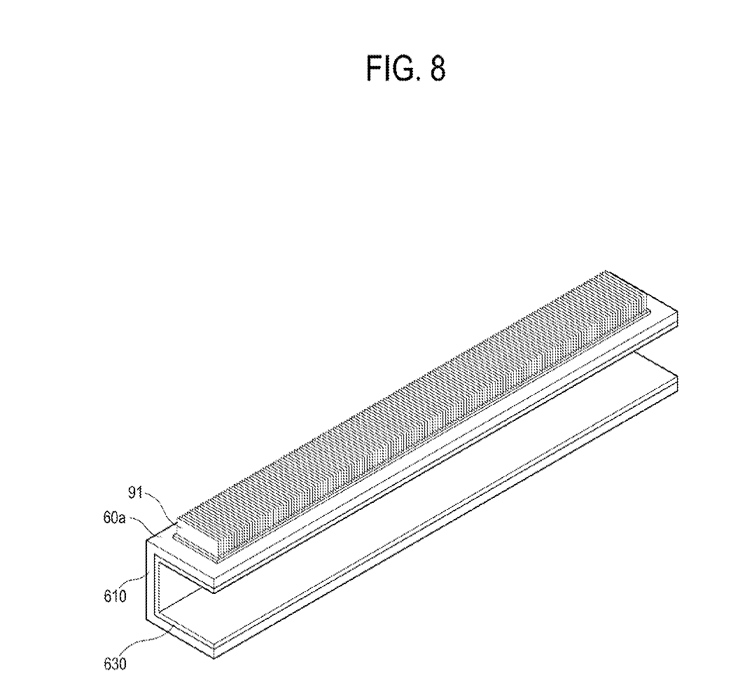

Referring to FIG. 8, an LCD according to an exemplary embodiment of the present invention will be described.

A radiation member 91 is provided on a first surface 60a of a plate 610 which faces a lower surface 80a of a lower cover 80. The radiation member 91 is provided throughout the first surface 60a. Thus, temperature becomes low and uniform throughout a light source cover 60.

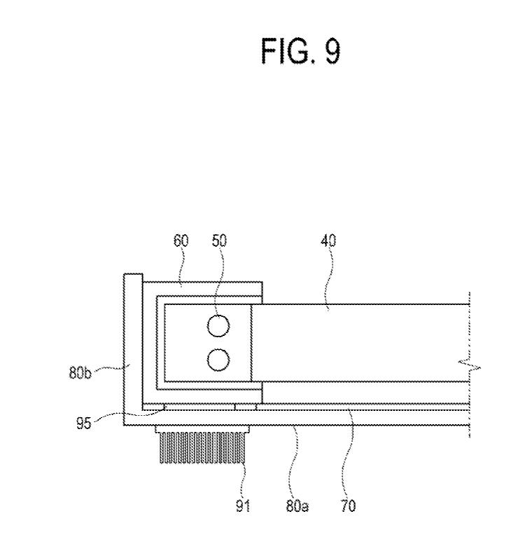

Referring to FIG. 9, an LCD according to an exemplary embodiment of the present invention will be described.

A radiation member 91 is provided on an external surface of a lower surface 80a of a lower cover 80. The radiation member 91 may be disposed substantially in the middle of a light source unit 50 or corresponding to the entire light source unit 50.

A gap pad 95 is provided between a first part 60a of a light source cover 60 and the lower surface 80a of the lower cover 80. The first part 60a of the light source cover 60, the lower surface 80a of the lower cover 80 and the gap pad 95 are closely arranged, e.g., adhered to one another in a sequential stack, and thus efficiency of heat conduction improves.

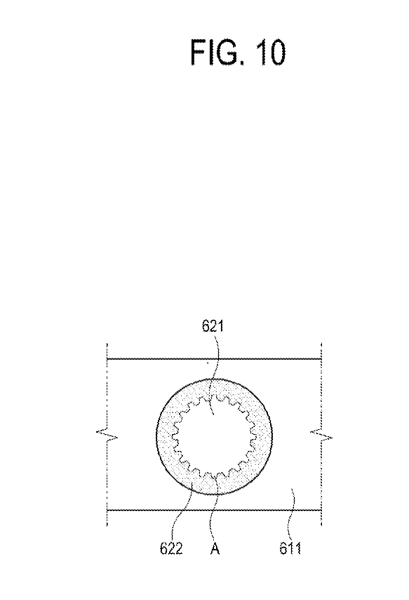

Referring to FIG. 10, an LCD according to an exemplary embodiment of the present invention will be described. FIG. 10 is a sectional view taken along IV-IV in FIG. 3.

A capillary structure part 622 extends lengthwise and includes a groove which induces capillarity. A refrigerant, liquefied in a condensation region, moves to an evaporation region through the groove.

The capillary structure part 622 of a heat pipe 620 may be modified variously to transmit the liquefied refrigerant to the evaporation region.

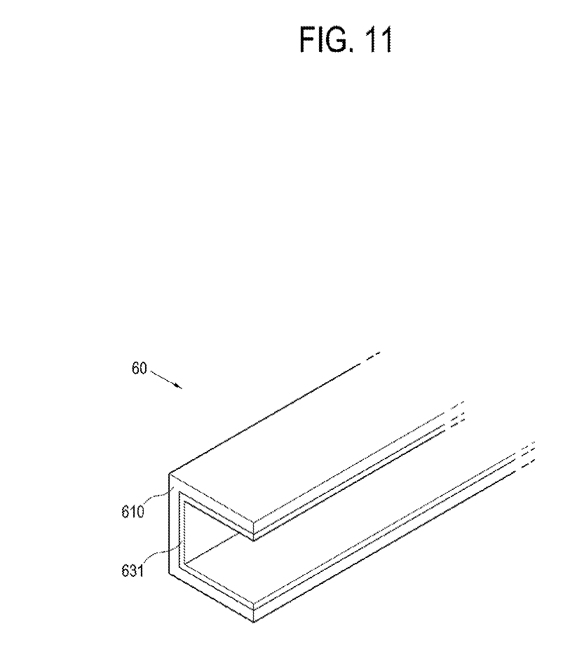

Referring to FIG. 11, an LCD according to an exemplary embodiment of the present invention will be described.

A light source cover 60 includes a plate 610 and a reflective layer 631. The reflective layer 631 is coated on an inner surface of the plate 610 and may include polyethylene terephthalate (PET) or the like.

Light from a light source unit 50 is reflected by the reflective layer 631 toward an incident surface 40a of a light guiding plate 40. In an implementation using the reflective layer 631, the light source cover 60 may be made thinner.

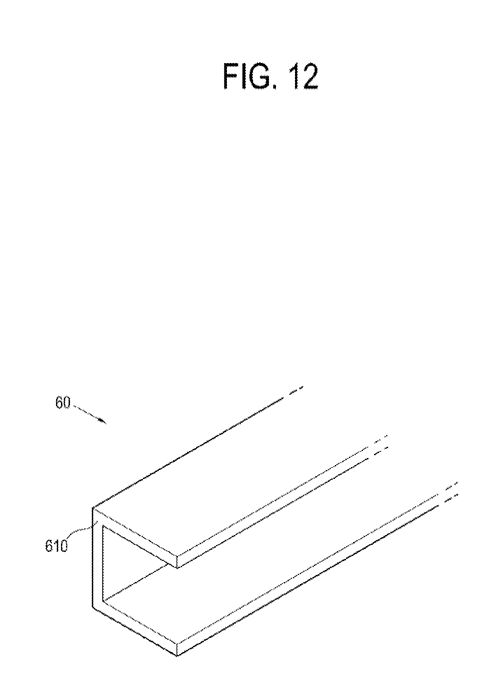

Referring to FIG. 12, an LCD according to an exemplary embodiment of the present invention will be described.

A light source cover 60 includes only a plate 610 without any additional element to reflect light. An inner surface of the plate 610 includes a mirror surface. The mirror surface may be formed by polishing, electron beam treatment, etc. Light from a light source unit 50 is reflected on the inner surface of the plate 610 toward an incident surface 40a of a light guiding plate 40. In an implementation of the light source cover 60 having a mirror surface, the light source cover 60 may be made even thinner.

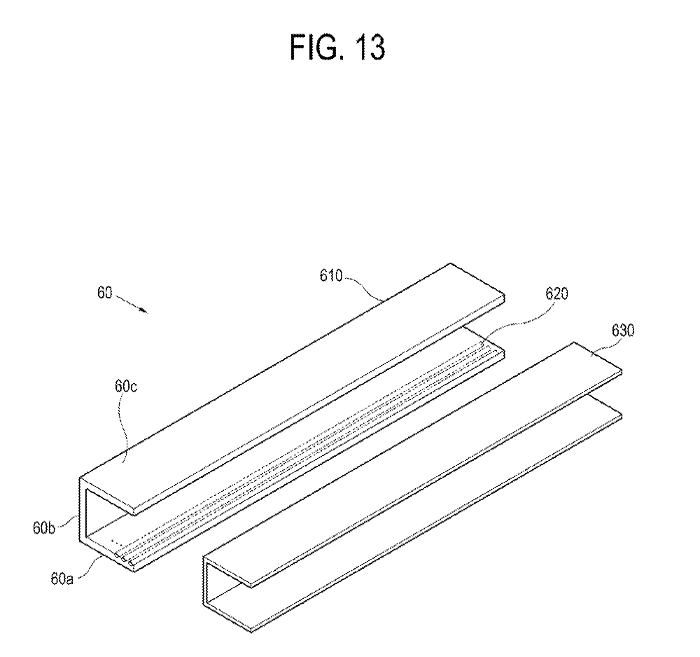

Referring to FIG. 13, an LCD according to an exemplary embodiment of the present invention will be described.

In a plate 610, a heat pipe 620 is formed only in a first surface 60a. In this case, the LCD may include a radiation member 91 formed on an external surface of a lower surface 80a of a lower cover 80.

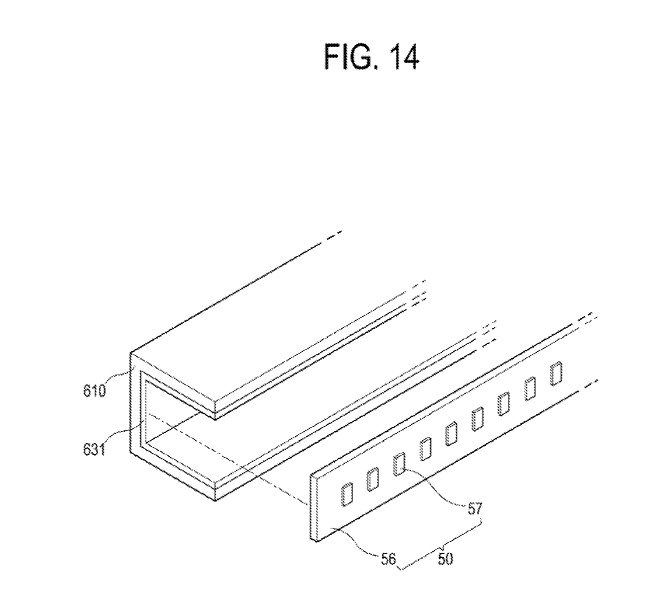

Referring to FIG. 14, an LCD according to an exemplary embodiment of the preset invention will be described.

A light source unit 50 includes a light emitting diode (LED) board 56 and LEDs 57 which are seated on the LED board 56. A portion of a light source cover 60 corresponding to the LEDs 57 may increase in temperature, but the light source cover 60 has an overall uniform temperature by the plate 610. An evaporation region of a heat pipe 620 is formed corresponding to the LEDs 57.

As described above, a display device dissipates heat generated in a light source.

Although exemplary embodiments of the present invention have been shown and described, it will be appreciated by those skilled in the art that changes may be made in embodiments without departing from the principles and spirit of the disclosure.

What is claimed is:

1. A display device comprising:
a liquid crystal display panel;
a light guiding plate disposed behind the liquid crystal display panel;
a light source unit disposed at a side of the light guiding plate; and
a light source cover encompassing the light source unit, for reflecting light from the light source unit to the light guiding plate, and comprising a plate in which a plurality of heat pipe are formed.

2. The display device according to claim 1, wherein the heat pipes extend substantially parallel with each other.

3. The display device according to claim 2, wherein the light source unit extends in a lengthwise direction, and the heat pipes extend in the lengthwise direction of the light source unit.

4. The display device according to claim 3, wherein the light source unit comprises a body and electrode parts, the electrode parts disposed at opposite end parts of the body.

5. The display device according to claim 4, wherein the plate comprises a first part corresponding to the electrode parts and a second part corresponding to at least a portion of the body.

6. The display device according to claim 5, further comprising a radiation member of which at least a portion is in contact with the second part.

7. The display device according to claim 6, wherein the radiation member comprises a heat sink.

8. The display device according to claim 5, wherein the plate encompasses the light source unit and is formed in a single body.

9. The display device according to claim 8, wherein the light source cover further comprises a light source reflecting plate disposed between the plate and the light source unit, and light from the light source unit is reflected by the light source reflecting plate.

10. The display device according to claim 9, wherein the light source reflecting plate comprises polyethylene terephthalate (PET).

11. The display device according to claim 5, wherein the light source cover further comprises a reflective layer coated on an inner surface of the plate, and light from the light source unit is reflected by the reflective layer.

12. The display device according to claim 11, wherein the reflective layer comprises polyethylene terephthalate (PET).

13. The display device according to claim 5, wherein the inner surface of the plate which faces the light source unit is a mirror surface, and light source from the light source unit is reflected by the inner surface of the plate.

14. The display device according to claim 5, wherein a thermal conductivity of the plate in a lengthwise direction of the light source cover is greater than a thermal conductivity thereof in a vertical direction of a surface of the plate.

15. The display device according to claim 5, further comprising a cover comprising a lower surface substantially parallel with the light guiding plate and a lateral surface bent from the lower surface forming an accommodating space where the light guiding plate and the light source cover are accommodated, wherein the plate is disposed to face the lower surface,
and a gap pad disposed between the plate and the lower surface of the cover, wherein the plate, the gap pad and the lower surface of the cover are adhered in a sequential stack.

16. The display device according to claim 5, wherein the plate further comprises a plate body encompassing the heat pipes and formed of a plate shape.

17. The display device according to claim 16, wherein the plate body comprises aluminum.

18. The display device according to claim 1, wherein the light source unit comprises a light emitting diode.

19. The display device according to claim 1, wherein the light source unit comprises a lamp,
wherein the lamp comprises a body and electrode parts, the electrode parts disposed at opposite end parts of the body.

20. The display device according to claim 19, wherein the heat pipes extend to correspond to at least one of the electrode parts and at least a portion of the body.
